(19) United States
(12) Patent Application Publication
(10) Pub. No.: US 2011/0087789 A1
(43) Pub. Date: Apr. 14, 2011

(54) SUBSCRIPTION BASED NETWORK ROUTING TABLES AND ENFORCEMENT FOR OVERLAY NETWORKS

(75) Inventors: Teemu Ilmari Savolainen, Nokia (FI); Basavaraj Patil, Coppell, TX (US)

(73) Assignee: Nokia Corporation, Espoo (FI)

(21) Appl. No.: 12/578,402

(22) Filed: Oct. 13, 2009

(51) Int. Cl. G06F 15/16

(52) U.S. Cl. 709/228

(57) ABSTRACT

A method and apparatus are provided according to one example embodiment to allow a user device to access services over an overlay network. The method and apparatus of one example embodiment further allows a user device, such as a mobile terminal, to move freely across network access points without interruption in the services. An example method may include receiving a request for service, allocating an address to the request, configuring rules associated with the request, generating at least one routing table entry from the rules, and providing for transmission of the routing table entry and the address. An address prefix may be associated with the service, in which case the address includes the address prefix. Further, the address prefix may be associated with a unique overlay network. Prior to transmitting the routing table entry, the request for service may require approval. The address may be a static or dynamic address.

### TECHNOLOGICAL FIELD

Embodiments of the present invention relate generally to communication technology and, more particularly, relate to a system, method, and apparatus for communicating over an overlay network.

### BACKGROUND

In network communications a single network user device may be separated from a larger network, such as the internet, by a gateway or router that serves a multitude of user devices on a sub-network, each with their own unique identifier or address. When a user initiates a session which could be accessing a web site or an application that accesses the internet, packets are exchanged between the source and the destination which may be identified by and IPv4 or IPv6 address. The gateway through which the user device accesses the larger network may use Network Address Translation (NAT) to transmit the request to the larger network. This NAT is a process by which the requested network address is modified or remapped from the sub-network address space into the larger network address space. The user device address may be masked by this process such that two requests coming from different user devices within the sub-network, after being processed through the NAT may be seen by the requested website or application as requests from the same network address. The network address seen by the requested websites or applications may be that of the routing device. The routing device may have several “public” addresses such that outgoing requests may be seen as originating from one of the plurality of public addresses.

Routing devices using NAT have become popular due to the shortage of addresses available on IPv4 as the application of NAT multiplexes the available addresses resulting in a virtually infinite number of addresses being available. However, there are drawbacks to NAT. As the internet is deployed with NATs and firewalls, applications need to implement NAT traversal techniques and may not be easily reachable from the internet and their peers.

### BRIEF SUMMARY

A method and apparatus are provided according to one example embodiment to allow a user device to access services while attached to an overlay network. The method and apparatus of one example embodiment further allows a user device, such as a mobile terminal, to move freely across network access points without interruption in the services.

An example method may include receiving a request for service, allocating an address to the request, configuring at least one rule associated with the request, generating at least one routing table entry from the at least one rule, and providing for transmission of the routing table entry and the address. An address prefix may be associated with the service, in which case the address includes the address prefix. Further, the address prefix may be associated with a unique overlay network. Prior to transmitting the routing table entry, the request for service may require approval. The address may be a static address.

Another example method may include providing for transmission of a request for service, receiving an address and at least one routing table entry in response to the request for service, and updating a routing table with the at least one routing table entry. The at least one routing table entry may further include at least one rule governing the network connection to the service. The example method may further include initiating a session of the service, obtaining the address, obtaining the at least one rule from the routing table, providing for transmission of a request for the session of the service to the address, and providing for transmission of data for the session of the service according to the at least one rule. The address may be a static address.

### BRIEF DESCRIPTION OF THE DRAWINGS

Having thus described some example embodiments of the invention in general terms, reference will now be made to the accompanying drawings, which are not necessarily drawn to scale, and wherein:

FIG. 1 illustrates a communication system according to an example embodiment of the present invention;

FIG. 2 illustrates an overlay network according to an example embodiment of the present invention;

FIG. 3 is a block diagram of an apparatus according to an example embodiment of the present invention;

FIG. 4 is a flow chart of a method of an overlay network according to an example embodiment of the present invention;

FIG. 5 illustrates an overlay network according to another example embodiment of the present invention;

FIG. 6 is a flow chart of a method of operating a user device according to an example embodiment of the present invention;

FIG. 7 is a flow chart of a method of an overlay network according to another example embodiment of the present invention;

FIG. 8 illustrates an overlay network according to another example embodiment of the present invention; and

FIG. 9 is a flow chart of a method of operating an overlay network according to an example embodiment of the present invention.

### DETAILED DESCRIPTION

Some example embodiments of the present invention will now be described more fully hereinafter with reference to the accompanying drawings, in which some, but not all embodiments of the invention are shown. Indeed, various embodiments of the invention may be embodied in many different forms and should not be construed as limited to the example embodiments set forth herein; rather, these example embodiments are provided so that this disclosure will satisfy applicable legal requirements. Like reference numerals refer to like elements throughout. As used herein, the terms “data,” “content,” “information” and similar terms may be used interchangeably to refer to data capable of being transmitted, received and/or stored in accordance with embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

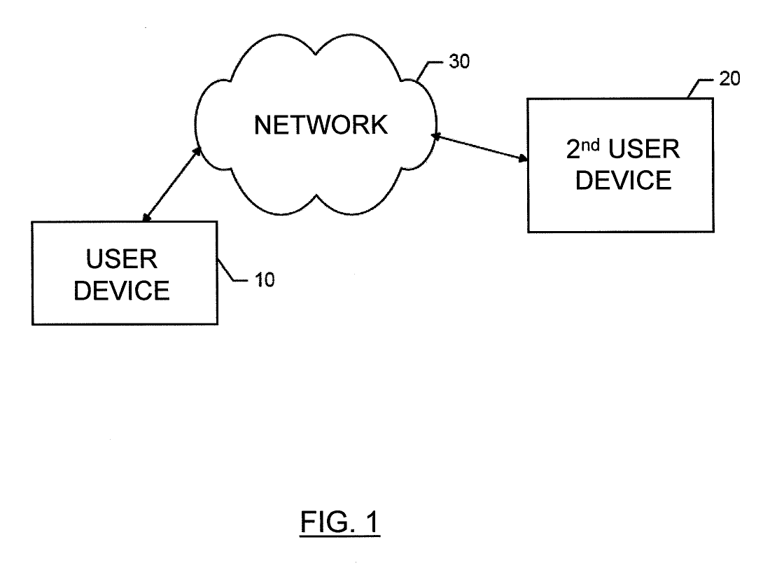

A session may be supported by a network 30 as shown in FIG. 1 that may include a collection of various different nodes, devices or functions that may be in communication with each other via corresponding wired and/or wireless interfaces. As such, FIG. 1 should be understood to be an example of a broad view of certain elements of a system that may incorporate example embodiments of the present invention and not an all inclusive or detailed view of the system or the network 30. Although not necessary, in some example embodiments, the network 30 may be capable of supporting communication in accordance with any one or more of a number of first-generation (1G), second-generation (2.G), 2.5G, third-generation (3G), 3.5G, 3.9G, fourth-generation (4G) mobile communication protocols. and/or the like.

One or more communication terminals such as the user device 10 and the second user device 20 may be in communication with each other via the network 30 and each may include an antenna or antennas for transmitting signals to and for receiving signals from a base site, which could be, for example a base station that is part of one or more cellular or mobile networks or an access point that may be coupled to a data network, such as a local area network (LAN), a metropolitan area network (MAN), and/or a wide area network (WAN), such as the Internet. In turn, other devices (e.g., personal computers, server computers or the like) may be coupled to the user device 10 and the second user device 20 via the network 30. By directly or indirectly connecting the user device 10 and the second user device 20 and other devices to the network 30, the user device 10 and the second user device 20 may be enabled to communicate with the other devices or each other, for example, according to numerous communication protocols including Hypertext Transfer Protocol (HTTP) and/or the like, to thereby carry out various communication or other functions of the user device 10 and the second user device 20, respectively.

In example embodiments, either of the user devices may be mobile or fixed communication devices. Thus, for example, the user device 10 and the second user device 20 could be, or be substituted by, any of personal computers (PCs), personal digital assistants (PDAs), wireless telephones, desktop computer, laptop computer, mobile computers, cameras, video recorders, audio/video players, positioning devices, game devices, television devices, radio devices, or various other devices or combinations thereof.

A user device may be configured to send a request access to a service, website, or application in the form of a network address, possibly in IPv4 or IPv6 protocol. The request may be sent through a router to the network. The router may employ a Network Address Translation that masks the user device's network address and re-maps the user device's address via a routing table to an address of the router. In one example embodiment, the address of the user device may be known as a private internet protocol (IP) address while the router address may be known as a public IP address. The service, website, or application receiving the request sees a request from the router address but does not see the address of the user device. Therefore, when the host of the service, website, or application sends information (also referred to as data or data packets), the host may send the information to the router address and the router, in turn, may send the data to the user device based on the routing tables generated at the router. This translation that is required to pass data through the router may add complexity and can slow the speed with which a user accesses the network. Further, if the user device is mobile and is moving between routers employing NAT while sending and receiving data, the complexity of the transition can lead to a disconnection from the requested service. When a mobile user device moves between network access points, the mobility protocol may be implemented by the provider of the service being accessed; therefore the service must follow the mobile user device as it moves between nodes and goes through multiple Network Address Translations.

In mobile applications, a user device may send a request while in the network of a first router employing a first NAT, but then after the connection is established and the user session has begun, the user device may move to the network of a second router. The service must then adapt to the second router address while providing continuous service. When such a transition occurs, established sessions may not survive the transition and the user session may be prematurely terminated. This potential outcome may result in a dissatisfied consumer and loss of revenue for a service provider. In an example embodiment, internet protocol mobility may be implemented by each service provider implementing service level roaming for each service. A problem exists with how to deploy applications and circumvent Network Address Translators, Application Layer Gateways (ALGs) or firewall rules that complicate and can disrupt communication, particularly in mobile applications.

Inter-network and intra-network mobility can be improved using an overlay network, such as mobility enabled IP overlay network. In order to provide further context for some example embodiments of an IP overlay network, a few select examples of an IP overlay network will be described. In an example embodiment, an overlay network may be a network that is built on top of another network. An overlay network may be a network restricted to use by a particular group of users, such as subscribers to said overlay network. An overlay network may provide access to sites and services otherwise not available to users outside of the overlay network. These sites and services may be hosted on a server within the overlay network, or they may be hosted on a third party server that may be accessed through the overlay network. Overlay networks may improve the robustness and availability of network paths between hosts.

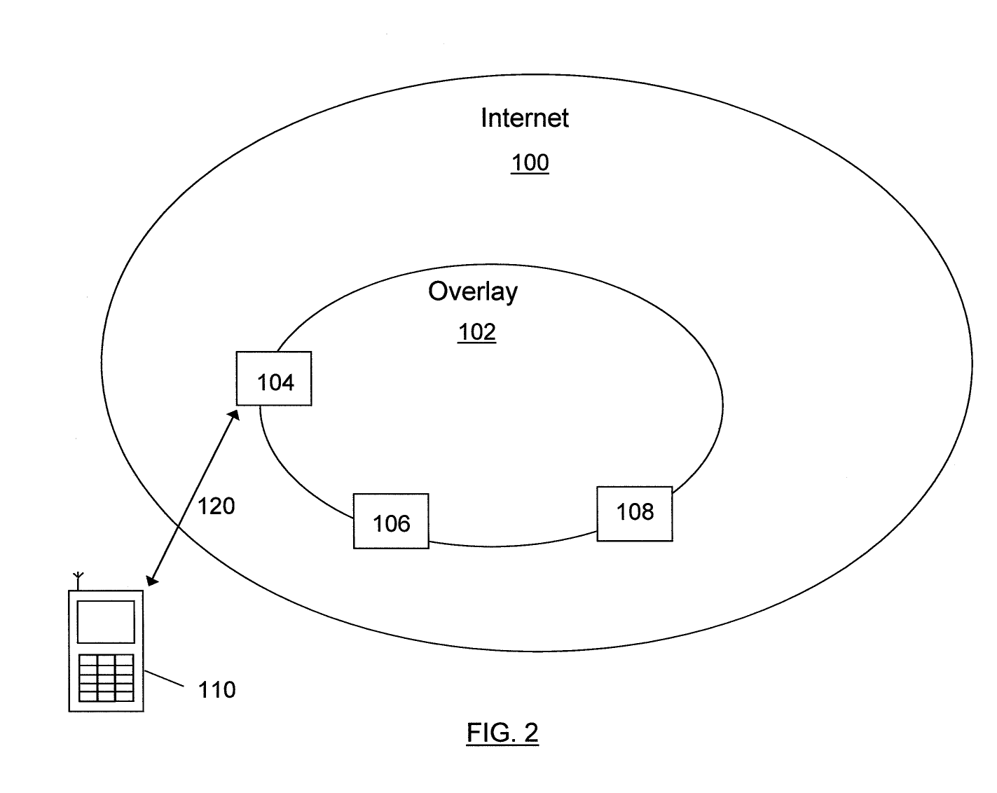

An overlay network may be supported by one or more cooperating hosts as illustrated in FIG. 2. The overlay network 102 of this example may be a sub-network of the internet 100 and may be maintained by at least one host or home agent 104. However, the overlay network may be a sub-network of other networks in other embodiments. The overlay network may further comprise other elements that may be collocated with the home agent 104 or reside separately on the overlay network 102, such as a policy enforcement entity 106 and a service subscription and control entity 108. Further details of the functions of these entities will be described below.

In an example embodiment of the IP overlay network described herein and illustrated in FIG. 2, a mobile node or user device 110 may be configured, such as by its execution of software that is provided by, or configured to access, the overlay network 102 under the appropriate conditions. Such software may contain information about which requests are sent to the overlay network 102 and which requests are sent to the internet network 100. This information may be contained in a routing table within or accessible by the user device. Before sending requests to a network, the user device may reference the routing table or address pool to determine if the request is to be directed to a specific address and if so, is the address on the internet 100 or on the overlay network 102. The user device, such as the software executed by the user device, may be dynamically and automatically updated by the overlay network 102. This reliance upon the routing table may reduce the load on the overlay network 102 by directing traffic for which the overlay network may not be involved to the internet network 100. When requests are sent from the user device 110 across the internet network 100, however, the request may still go through a router employing NAT and the aforementioned issues may reduce the session performance, mobility, or the overall user experience.

The overlay network 102 may be configured to support services that may be provided by a host of the overlay network or provided by a remote server or other network entity. Some services supported by the overlay network 102 may include a fee arrangement between the overlay provider and the service provider or the originator of the service. A user of the overlay network may subscribe to services that are supported by the overlay network in a variety of ways such as through contracts (i.e., monthly, annual, etc.) and/or pay-per-use services among others. Such services may be in the form of Voice Over Internet Protocol (VOIP), social networking services, global positioning or mapping services, or any other service that may be provided over a network. Some services supported by the overlay network may provide exclusive content for subscribers of the overlay network such as a secure internet mail service or an instant messaging service.

Advantageously, for a service supported by the overlay network 102 the connection speed and reliability of the connection may be increased relative to the provision of the same service over the internet, thereby benefiting both the user and the service provider. The connection speed may be increased due to the overlay network only being available to subscribers, which may allow greater bandwidth to be allocated to each user, whereas a service that is provided by the internet, but not the overlay network, may see a reduction in per user bandwidth when a plurality of users are accessing the service at the same time. The service may also be more reliable as compared to the same service being supported by the internet as the user device may be connected directly to the overlay network which can control and govern the connection. Further details of how the service may be more reliable are detailed below.

As noted above, an overlay network may be configured as illustrated in the example embodiment of FIG. 2, wherein the overlay network 102 comprises a home agent entity 104, a policy enforcement entity 106, and a service subscription and control entity 108. There may be any number of each of these elements and they may be collocated in a single physical entity. The home agent 104 may be the primary connection point to the overlay network for the user device 110 as illustrated by the connection line 120. The home agent 104 may ultimately govern the connection between the overlay network and the user device 110. The home agent 104 may implement the network side support of the overlay network and may provide a fixed address, such as a fixed IP address, for the user device such that subscription and enforcement rules can be configured for that user device.

The service subscription and control entity 108 may be in communication with the virtual storefront through which a user signs up for a service and/or pays for a service. The service subscription and control entity 108 may retain the user information such that there may be a record of authorized subscribers and the status of their subscriptions or accounts. This record of authorized subscribers may be maintained as a table that includes network addresses for each subscribed user device. When a service request is received at the service subscription and control entity 108, the home agent 104 provides the service subscription and control entity 108 with a fixed address, such as a fixed IP address, and the service subscription and control entity 108 appends a prefix to the fixed address that may be associated with the service requested. The result of the fixed address and the appended prefix may be a service-specific address that may be provided to the user device 110. The service subscription and control entity 108 may configure a routing table update to be sent to the user device 110 by the home agent 104 together with the address. The routing table update and address that may be provided to the user device 110 may enable the user device 110 to connect directly to the requested service by navigating to the service-specific address. The software of the user device may be configured to reference the routing table before each service request such that future requests for the service by the user device 110 may reference the routing table and send the request directly to the service-specific address resulting in a faster, more reliable connection to the service.

The policy enforcement entity 106 may be configured to assign and maintain rules for the subscribed users to send information packets to internal and/or external locations relative to the overlay network 102. The policy enforcement entity 106 may maintain rules that govern the information transfer between the overlay network 102 and the user devices 110. The policy enforcement entity 106 may receive a request from the service subscription and control entity 108 regarding a requested service and the policy enforcement entity 106 may provide to the service subscription and control entity 108 a set of rules to be incorporated into the routing table update that may be sent to the user device 110. The rules included in a routing table update may ensure that the user device 110 operates properly when in a session with the service associated with the routing table entry. The policy enforcement module 106 may further maintain an access control list that serves as a firewall for the overlay network or for service providers.

The user device may maintain a routing table with rules that apply to each service-specific address for services to which the user device may be subscribed. When a user directs the user device to access a particular service, the user device may use the routing table to determine the rules associated with a particular service-specific address to use to access the requested service. Navigating to the service-specific address may permit faster communications and easier accessibility, while also operating on an overlay network that may not be subject to the same inefficiencies as the internet, such as firewalls and NATs.

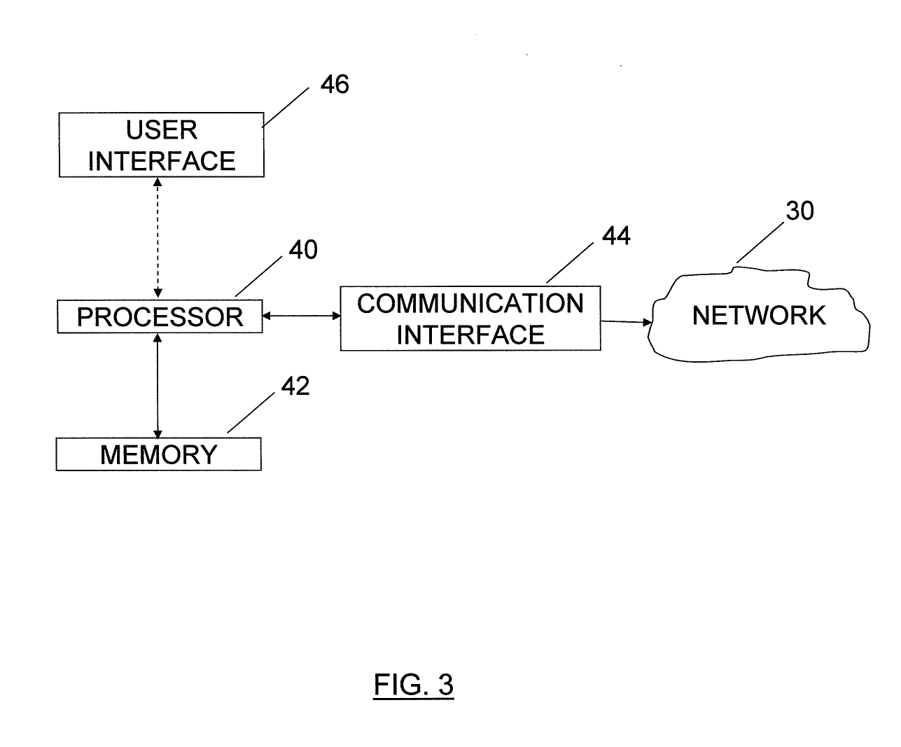

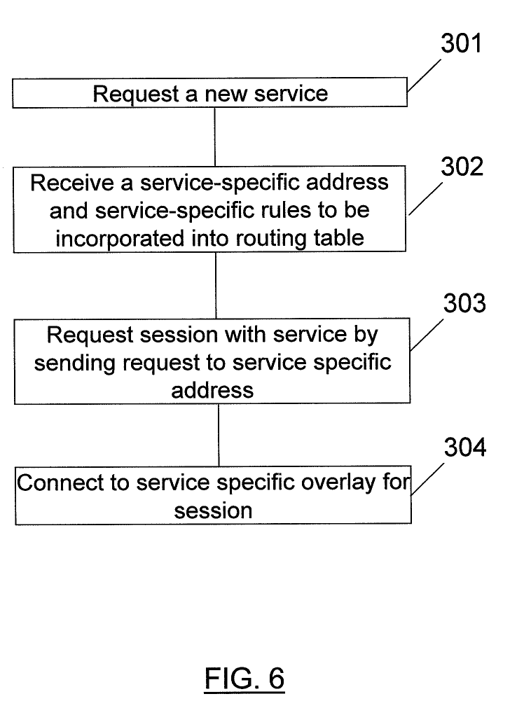

The overlay network may be established by a host device, such as a server, as described above. The host device may be embodied in various manners, but in one example embodiment it may be embodied as shown in FIG. 3 and may be configured to perform example methods of the present invention, such as those described with respect to FIGS. 6 and/or 9. The example host device includes or may otherwise be in communication with a processor 40, a memory device 42 and a communications interface 44. The processor 40 may be embodied as various means implementing various functionality of example embodiments of the present invention including, for example, a microprocessor, a coprocessor, a controller, a special-purpose integrated circuit such as, for example, an ASIC (application specific integrated circuit), an FPGA (field programmable gate array), or a hardware accelerator, processing circuitry or the like. According to one example embodiment, processor 40 may be representative of a plurality of processors, or one or more multiple core processors, operating in concert. Further, the processor 40 may comprise a plurality of transistors, logic gates, a clock (e.g., oscillator), and the like to facilitate performance of the functionality described herein. The processor 40 may, but need not, include one or more accompanying digital signal processors. In some example embodiments, the processor 40 may be configured to execute instructions stored in the memory device 42 or instructions otherwise accessible to the processor 40. The processor 40 may be configured to operate such that the processor causes the host device to perform various functionalities described herein. Whether configured as hardware or via instructions stored on a computer-readable storage medium, or by a combination thereof, the processor 40 may be an entity capable of performing operations according to embodiments of the present invention while configured accordingly. Thus, in example embodiments where the processor 40 may be embodied as an ASIC, FPGA, or the like, the processor 40 may be specifically configured hardware for conducting the operations described herein. Alternatively, in example embodiments where the processor 40 may be embodied as an executor of instructions stored on a computer-readable storage medium, the instructions specifically configure the processor 40 to perform the algorithms and operations described herein. In some example embodiments, the processor 40 may be a processor of a specific device (e.g., a mobile terminal) configured for employing example embodiments of the present invention by further configuration of the processor 40 via executed instructions for performing the algorithms and operations described herein. 10034] The memory device 42 may be one or more computer-readable storage media that may include volatile and/or non-volatile memory. In some example embodiments, the memory device 42 includes Random Access Memory (RAM) including dynamic and/or static RAM, on-chip or off-chip cache memory, and/or the like. Further, memory device 42 may include non-volatile memory, which may be embedded and/or removable, and may include, for example, read-only memory, flash memory, magnetic storage devices (e.g., hard disks, floppy disk drives, magnetic tape, etc.), optical disc drives and/or media, non-volatile random access memory (NVRAM), and/or the like. Memory device 42 may include a cache area for temporary storage of data. In this regard, some or all of memory device 42 may be included within the processor 40.

Further, the memory device 42 may be configured to store information, data, applications, computer-readable program code instructions, or the like for enabling the processor 40 and the example host device to carry out various functions in accordance with example embodiments of the present invention described herein. For example, the memory device 42 could be configured to buffer input data for processing by the processor 40. Additionally, or alternatively, the memory device 42 may be configured to store instructions for execution by the processor 40.

The communication interface 44 may be any device or means embodied in either hardware, a computer program product, or a combination of hardware and a computer program product that may be configured to receive and/or transmit data from/to a network and/or any other device or module in communication with the example apparatus. Processor 40 may also be configured to facilitate communications via the communications interface by, for example, controlling hardware included within the communications interface 44. In this regard, the communication interface 44 may include, for example, one or more antennas, a transmitter, a receiver, a transceiver and/or supporting hardware, including a processor for enabling communications with network 30. Via the communication interface 44 and the network 30, the example host device may communicate with various other network entities in a device-to-device fashion and/or via indirect communications via a base station, access point, server, gateway, router, or the like.

The communications interface 44 may be configured to provide for communications in accordance with any wired or wireless communication standard. The communications interface 44 may be configured to support communications in multiple antenna environments, such as multiple input multiple output (MIMO) environments. Further, the communications interface 44 may be configured to support orthogonal frequency division multiplexed (OFDM) signaling. In some example embodiments, the communications interface 44 may be configured to communicate in accordance with various techniques, such as, second-generation (2G) wireless communication protocols IS-136 (time division multiple access (TDMA)), GSM (global system for mobile communication), IS-95 (code division multiple access (CDMA)), third-generation (3G) wireless communication protocols, such as Universal Mobile Telecommunications System (UMTS), CDMA2000, wideband CDMA (WCDMA) and time division-synchronous CDMA (TD-SCDMA), 3.9 generation (3.9G) wireless communication protocols, such as Evolved Universal Terrestrial Radio Access Network (E-UTRAN), with fourth-generation (4G) wireless communication protocols, international mobile telecommunications advanced (IMT-Advanced) protocols, Long Term Evolution (LTE) protocols including LTE-advanced, or the like. Further, communications interface 44 may be configured to provide for communications in accordance with techniques such as, for example, radio frequency (RF), infrared (IrDA) or any of a number of different wireless networking techniques, including WLAN techniques such as IEEE 802.11 (e.g., 802.11a, 802.11b, 802.11g, 802.11n, etc.), wireless local area network (WLAN) protocols, world interoperability for microwave access (WiMAX) techniques such as IEEE 802.16, and/or wireless Personal Area Network (WPAN) techniques such as IEEE 802.15, BlueTooth (BT), low power versions of BT, ultra wideband (UWB), Wibree, Zigbee and/or the like. The communications interface 44 may also be configured to support communications at the network layer, possibly via Internet Protocol (IP).

As shown in FIG. 2, the home agent entity 104, the service subscription and control entity 108, and the policy enforcement entity 106 may each be configured as described above with respect to the host and illustrated in FIG. 3. Each may be independently located throughout the overlay network, any or all may be collocated, or they may be combined in a single host device as defined above and illustrated in FIG. 3.

Although described above in the context of the host device, a user device or other source may also be embodied by an example apparatus of the type depicted in FIG. 3, further including a user interface 46. The user interface 46 may be in communication with the processor 40 to receive user input via the user interface 46 and/or to present output to a user as, for example, audible, visual, mechanical or other output indications. In this regard, the processor may comprise user interface circuitry configured to control at least some functions of one or more elements of the user interface. The processor and/or user interface circuitry of the processor may be configured to control one or more functions of one or more elements of the user interface through computer program instructions (e.g., software and/or firmware) stored on a memory accessible to the processor (e.g., volatile memory, non-volatile memory, and/or the like). The user interface 46 may include, for example, a keyboard, a mouse, a joystick, a display (e.g., a touch screen display), a microphone, a speaker, or other input/output mechanisms.

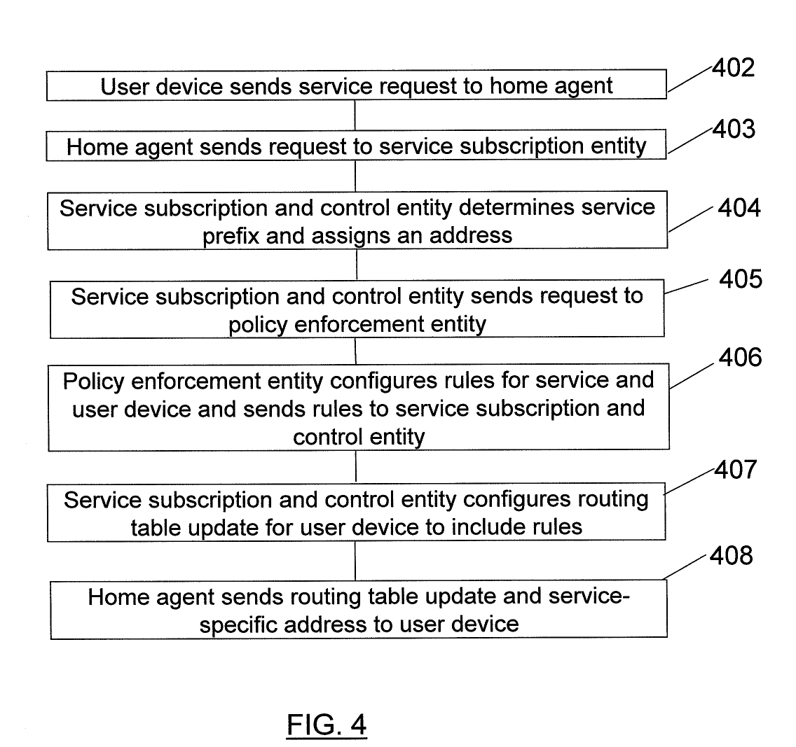

An example embodiment of an overlay network in accordance with one example embodiment is presented by FIG. 2 to illustrate some of the advantages of overlay networks and service-specific overlay networks. The flowchart illustrating operations performed by or in relation to the service-specific overlay network of this example embodiment is presented in FIG. 4 and may be performed, for example, by the server such as shown in FIG. 3. It will be understood that each block or step of the flowcharts, and combinations of blocks in the flowcharts, may be implemented by various means, such as hardware, firmware, processor, circuitry and/or other device(s) associated with execution of software including one or more computer program instructions. For example, one or more of the procedures described above may be embodied by computer program instructions. In this regard, the computer program instructions which embody the procedures described above may be stored by a memory device 42 of an apparatus, such as a client, employing an example embodiment of the present invention and executed by a processor 40 in the apparatus. As will be appreciated, any such computer program instructions may be loaded onto a computer or other programmable apparatus (e.g., hardware), such as depicted in FIG. 3, to produce a machine, such that the resulting computer or other programmable apparatus embody means for implementing the functions specified in the flowchart block(s). These computer program instructions may also be stored in a computer-readable memory that may direct a computer or other programmable apparatus, e.g., the overlay network host, to function in a particular manner, such that the instructions stored in the computer-readable memory produce an article of manufacture the execution of which implements the function specified in the flowchart block(s). The computer program instructions may also be loaded onto a computer or other programmable apparatus to cause a series of operational steps to be performed on the computer or other programmable apparatus to produce a computer-implemented process such that the instructions which execute on the computer or other programmable apparatus provide steps for implementing the functions specified in the flowchart block(s).

Accordingly, blocks of the flowcharts support combinations of means for performing the specified functions, combinations of steps for performing the specified functions and program instruction means for performing the specified functions. It will also be understood that one or more blocks of the flowchart, and combinations of blocks in the flowcharts, can be implemented by special purpose hardware-based computer systems which perform the specified functions, or combinations of special purpose hardware and computer instructions. The function of each operation of the flowcharts described herein may be performed by a processor bringing about the operation or transformation set forth in the flow chart operations.

An example embodiment of an overlay network will be described herein with reference to the diagram of FIG. 2 and the flowchart of FIG. 4. A user device 110 may send request for a service to the overlay network 102. The home agent entity 104 may receive the request for a new service subscription and send the request to the service subscription and control entity 108 as in operations 402 and 403 of FIG. 4. The service subscription and control entity 108 may obtain an address prefix, such as an IP address prefix, that may be uniquely associated with the requested service as in operation 404 and select a static address, such as a static IP address, including that prefix. The service subscription and control entity 108 may append the service-specific prefix to the static address and obtain a service-specific address that may be uniquely configured for the requesting user device 110 and the service that may be requested. The service subscription and control entity 108 may send the service request to the policy enforcement entity 106 as in operation 405. The policy enforcement entity 106 may determine the rules to be associated with the service. These rules based, for example, upon predefined criteria maintained by the policy enforcement entity 106, may be based on the service itself, the user device requesting the service, or a combination thereof as in operation 406. The rules may regulate how and what data may be transmitted between the service provider and the user device 110 among other service-specific rules. The policy enforcement entity 106 may provide the rules to the service subscription and control entity 108. The service subscription and control entity 108 may then configure a routing table update that includes the service-specific rules and may send this routing table update to the home agent entity 104. The home agent entity 104 may then send the routing table update and the service-specific address to the user device 110 whereupon the user device 110 may update the routing table maintained at the user device 110 as in operation 408. Upon subsequent requests by the user device 110 for the service, the user device may obtain the service-specific address and reference the routing table to determine the rules that govern connection to the service-specific address before connecting to the service-specific address.

Another example embodiment may entail a dynamically assigned address. An address may remain static during a session with a particular device even through movement throughout the overlay network; however, when a connection is terminated, or when a device is restarted, the next request from the device for the service may be assigned a different address from the overlay network.

Additionally, in some example embodiments, the request for a service may come from a first entity or device, and the address and routing table entry may be sent to a second entity or device. Such an embodiment may allow a user of a first device to request a service for a second user device or allow a service provider to request that a service subscription be sent to a user device.

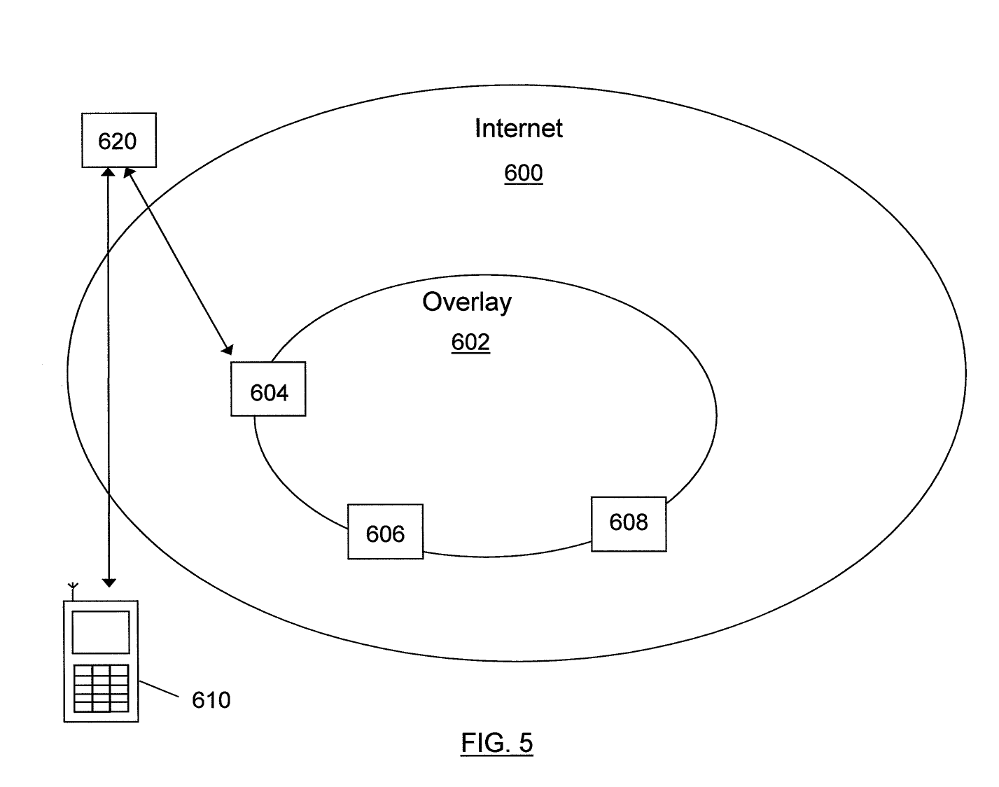

In another example embodiment of the overlay network illustrated in FIG. 5, a user device 610 may navigate to a third-party website 620 or server that may not be within the overlay network 602 over a network, such as the internet 600. The user device 610 may request a service from the third-party host 620 that may be fulfilled via the overlay network. Websites and service providers that are configured to provide services to mobile devices use a device recognition platform to identify the type of device requesting the service or web page to optimize delivery of the service or web page. The third-party host 620 may recognize the requested service as being provided by the overlay network (i.e., the third-party host may work in concert with the overlay network provider) and may also identify the user device 610 as compatible with the overlay network 602 (i.e., by virtue of the device recognition platform) and may then direct the service request to the home agent 604 of the overlay network 602. The service request may then undergo the same process earlier described; however once the routing table update is configured and sent to the home agent 604, the routing table update and service-specific address may then be sent to the third-party host 620 for relay to the user device 610. In such an embodiment, a third party service provider may benefit from improved service to the user device by operating over the overlay network. When the user device 610 requests a session of the newly subscribed service, the service-specific address earlier provided to the user device 610 may direct the user device to connect to the service via the overlay network 602. The user of the user device 610 may not be aware of whether they are connected via the internet 600 or the overlay network 602. Optionally, the user device 610 of the above example embodiment may be re-directed by a third-party website 620 to the overlay network 602 once a request for service has been received such that the overlay network 602 may communicate directly with the user device 610 for subscription to the service.

The flowchart of FIG. 6 shows an example embodiment of a method of a user device operating over the overlay network as previously described. The user device may request a new service at operation 301. A service-specific address for the user device and service-specific rules may be generated on the overlay network and sent to the user device as in operation 302. Subsequently, as shown in operation 303, the user device may send a request for a session of the service by sending a request to the service-specific address using the service-specific rules obtained in operation 302. The user device may then connect with the overlay network for the session with the service in operation 304.

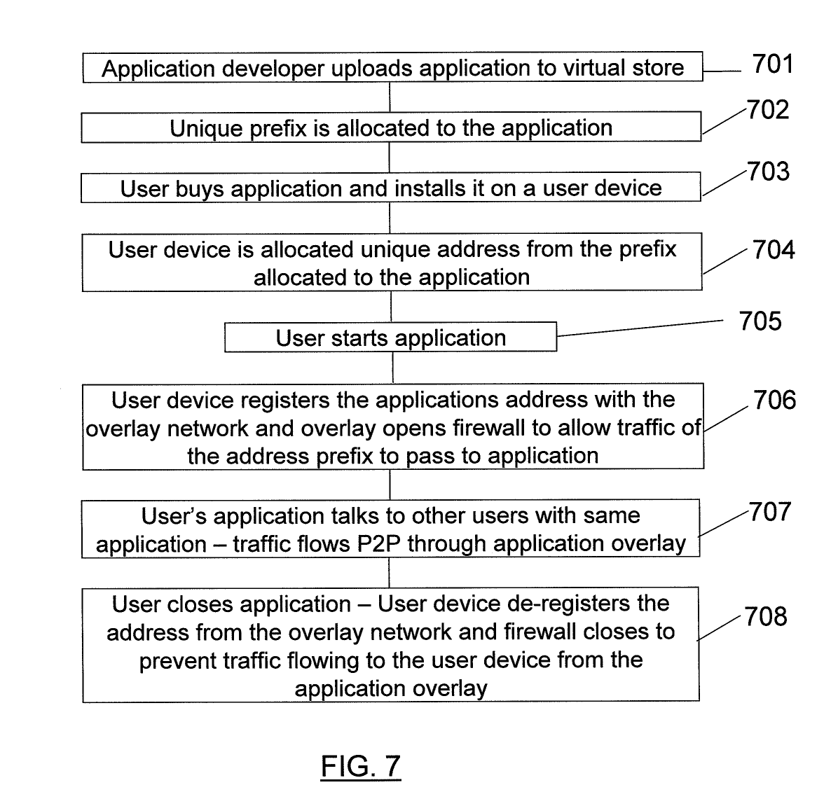

A service-specific overlay may be created for any or all of the services available on the overlay network. An example embodiment of the application of service-specific overlays is illustrated in the flowchart of FIG. 7. A service or application may be loaded by an application developer onto a virtual store that may be associated with the overlay network as in operation 701. The application or service may then be allocated a service-specific address prefix, such as an IPv6 prefix. The application or service may also be allocated an overlay network that may be exclusively assigned to the service-specific address prefix. When a user requests the service or application, the user device may be assigned an address, such as a static IP address, with the service-specific address prefix appended, and sent to the user device together with a routing table update provided by the overlay network as in operation 704. When the user device initiates a session with the service or application, the user device may connect directly to the service-specific address provided by the overlay network and that service-specific address may be within a service-specific overlay network such that the only users operating on the service-specific overlay network are those that are in an active session with the same service. Connection with the service-specific overlay may also open a firewall to allow traffic of the same service-specific overlay network to pass to the application on the user device as in operation 706. Such service-specific overlays may be used in Peer-to-Peer (P2P) applications such as VOIP or interactive games. The service-specific overlay network may allow users to communicate with each other over the overlay network without interference from a firewall or a NAT, as the overlay network may serve as the secure portal through which each user may be connected. No firewall communication would be required between hosts or users as the service could be trusted to operate correctly via the overlay network. The overlay network may monitor the applications for those behaving incorrectly and subsequently block the application and the related prefix. When the user closes the service or terminates the session, the user device may un-register from the service-specific overlay network and close the firewall to prevent traffic from the overlay network from flowing to or from the user device.

An advantage to each service having a service-specific overlay may be that the user devices operating on that service-specific overlay may be unimpeded by devices using the internet, but not the same service. This may be beneficial in peer-to-peer applications such as games or VOIP among other services. Several services may use the same service-specific overlay in some cases as they may be related or traffic for each service on the service-specific overlay may be at low enough levels to allow multiple services to be hosted by the same overlay network.

Further advantages to the overlay network may include more robust connections enhancing the mobility of user devices. When a user device is connected to a service via the overlay network, the user device may be connected through a service-specific address that may be static and does not change when the user device changes network access points. Further, communication from the service may be directed through the overlay network directly to the user device rather than through a router employing NAT. Such direct communication and the stability of IP addresses enhances the reliability of the service sessions and provides a more robust connection to the overlay network that may be less likely to be disconnected prematurely since there are no changing addresses for the services to routinely update.

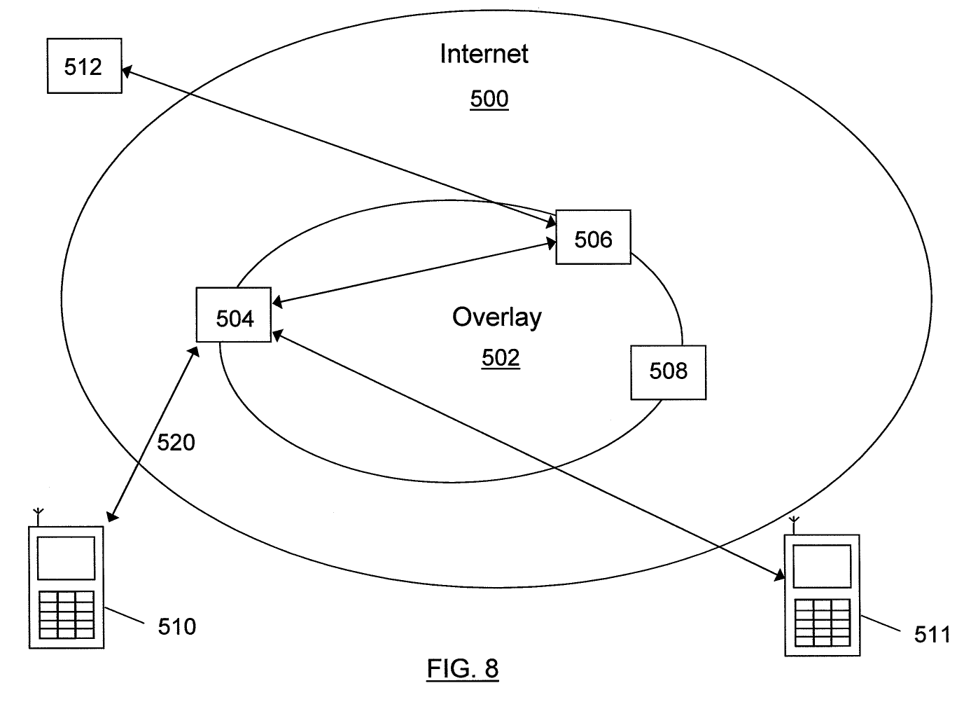

An embodiment of an implementation of the overlay network is illustrated in FIG. 8. A game server 512 may be a third party host that is connected to the overlay network 502. The game server 512 may be accessed via a subscription over the overlay network 502 such that a user device 510 can access the game server through the overlay network. Multiple user devices 510 and 511 may access the game server 512 on an overlay network (perhaps an application specific overlay network exclusively for the game server 512) for peer-to-peer (P2P) game play. In the illustrated example embodiment, the user devices 510 and 511 access the overlay network through a home agent entity 504. The home entity agent 504 may be in communication over the overlay network to the policy enforcement entity 506 that may be in communication with the game server host 512. The user devices 510 and 511 may communicate with each other through the overlay network 502 thus obviating the need for NAT traversal or a firewall as the overlay network 502 may provide the necessary security and the network addresses without masquerading. This approach allows for more efficient communications with the game server host 512 and between the user devices 510 and 511 while protecting them without requiring a firewall.

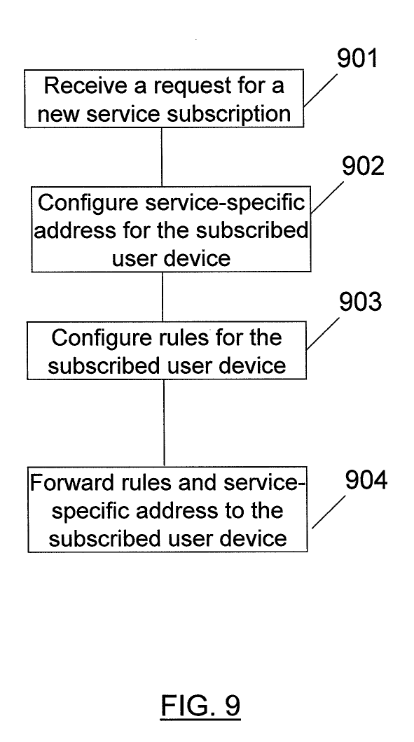

As shown in FIG. 9 in accordance with one example embodiment of the present invention, a method may include initially receiving a request for a new service subscription. See operation 901. The example method may then configure a service-specific address for the subscribed user device as in operation 902. The example method may then configure the rules for the subscribed service. See operation 903. Further, the example method may forward the service-specific address and the rules to the subscribed user device, the rules possibly sent in the form of a routing table update as in operation 904.

In another example embodiment, an apparatus, such as shown in FIG. 3, for performing the method of FIG. 4 above may comprise a processor 40 configured to perform some or each of the operations (901-904) shown in FIG. 9. The processor may, for example, be configured to perform the operations (901-904) or to control the example apparatus with respect to performing operations (901-904) by performing hardware implemented logical functions, executing stored instructions stored, for example, in memory device 42, or executing algorithms for performing each of the operations. Alternatively, the example apparatus may comprise means for performing each of the operations as described above. In this regard, according to an example embodiment, examples of means for performing operations 901-904 may comprise the structure associated with, for example, the processor and/or a device or circuit for executing instructions or executing an algorithm for processing information as described above. As such, in some example embodiments, such as shown in FIG. 3, the apparatus for performing the method of FIG. 9 may include at least one processor and at least one memory storing computer program code that may be accessed and executed by the processor 40. The at least one memory and the computer program code may be configured to, with the processor, perform the operations (901-904).

In another example embodiment, an apparatus may be provided that includes at least one processor 40 and at least one memory 42 including computer program code. The at least one memory and the computer program code of this example embodiment are configured to, with the at least one processor, cause the apparatus to receive a request for a new service subscription, configure a service-specific IP address for the subscribed user device, configure rules for the subscribed user device, and forward the rules and service-specific IP address to a user device.

In yet another example embodiment, a computer program product comprising a computer-readable storage medium, e.g., memory device 42, having computer-readable program instructions stored therein. The computer-readable program instructions of this example embodiment may include program instructions to receive a request for a new service subscription. The computer-readable program instructions may also include program instructions to configure a service-specific IP address for the subscribed user device and to configure rules for the subscribed user device. Further, the computer-readable program instructions may include program instructions to forward the rules and service-specific IP address to the subscribed user device.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a request for a service;
allocating an address to the request;
associating rules with the request;
generating from the rules at least one routing table entry; and
providing for transmission of the address and the at least one routing table entry.

2. The method according to claim 1, further comprising determining an address prefix associated with the service, wherein allocating an address to the request comprises including the address prefix in the address.

3. The method according to claim 2, wherein the prefix is associated with a unique overlay network.

4. The method according to claim 1, further comprising authorizing the request for service.

5. The method according to claim 1, further comprising storing the request and the associated at least one routing table entry.

6. The method according to claim 1, wherein the address is a static address.

7. An apparatus comprising:
at least one processor; and
at least one memory including computer program code, the at least one memory and the computer program code configured to, with the at least one processor, cause the apparatus at least to perform:
receive a request for a service;
allocate an address to the request;
associate rules with the request;
generate from the rules at least one routing table entry; and
provide for transmission of the address and the at least one routing table entry.

8. An apparatus according to claim 7, wherein the at least one memory and the computer program code are configured to, with the at least one processor, cause the apparatus to determine an address prefix associated with the service, wherein allocating an address to the request comprises including the address prefix in the address.

9. An apparatus according to claim 8, wherein the address prefix is associated with a unique overlay network.

10. An apparatus according to claim 7, wherein the at least one memory and the computer program code are configured to, with the at least one processor, cause the apparatus to authorize the request for service.

11. An apparatus according to claim 7, wherein the at least one memory and the computer program code, are configured to, with the at least one processor, cause the apparatus to store the request and the at least one routing table entry.

12. An apparatus according to claim 7, wherein the address is a static address.

13. An apparatus according to claim 7, wherein the apparatus comprises a server that includes a processor, a memory, and a communications interface.

14. A computer program product comprising at least one computer-readable storage medium having computer-readable program instructions stored therein, the computer-readable program instructions configured to cause an apparatus at least to perform:
receive a request for a service;
allocate an address to the request;
associate rules with the request;
generate from the rules at least one routing table entry; and
provide for transmission of the address and the at least one routing table entry.

15. A computer program product according to claim 14, wherein the computer-readable program instructions are further configured to cause the apparatus to determine an address prefix associated with the service, wherein allocating an address to the request comprises including the address prefix in the address.

16. A computer program product according to claim 15, wherein the address or prefix is associated with a unique overlay network.

17. A computer program product according to claim 14, wherein the computer-readable program instructions are further configured to cause the apparatus to authorize the request for service.

18. A computer program product according to claim 14, wherein the computer-readable program instructions are further configured to cause the apparatus to store the request and the at least one routing table entry.

19. A method comprising:
providing for transmission of a request for a service;
receiving at least one routing table entry and an address associated with the service in response to the request for service;
updating a routing table with the at least one routing table entry; and
storing the address associated with the service.

20. The method of claim 19, wherein the at least one routing table entry comprises at least one rule governing a network connection to the service.

21. The method of claim 20, further comprising:
initiating a session of the service;
obtaining the address associated with the service;
obtaining the at least one rule from the routing table;
providing for transmission of a request for said session of the service to the address associated with the service; and
providing for transmission of data for said session of the service according to the at least one rule.
